(19) United States
(12) Patent Application Publication
(10) Pub. No.: US 2005/0144432 A1
(43) Pub. Date: Jun. 30, 2005

(54) Method for updating BIOS setting

(76) Inventor: Chih-Wei Wu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,651

(22) Filed: Dec. 30, 2003

(51) Int. Cl. G06F 9/24

(52) U.S. Cl. 713/2

(57) ABSTRACT

A method for updating BIOS setting is provided. It uses additional memory to store at least one set of system configuration settings so that the user can change the setting in a few seconds after power-on in order to save the time for changing the BIOS setting and to conveniently change the BIOS setting.

### BACKGROUND OF INVENTION

1. Field of the Invention

This invention generally relates to a method for updating BIOS setting, and more particularly to a method for simplification of updating BIOS setting.

2. Description of Related Art

As the technology advances, the data processing device have been widely applied to every field and provide more versatile functions. However, almost all data processing devices require the BIOS (Basic Input Output System).

FIG. 1 shows the interaction between the conventional BIOS firmware and the CMOS (Complementary Metal-Oxide Semiconductor) hardware. Referring to FIG. 1, BIOS of a computer system will read or write RAM (random access memory) made of CMOS. BIOS can read/write on the CMOS to obtain the current configuration of the computer system, or record the setting of the configuration of the computer system (e.g., the time of the system) to the CMOS memory and set the proper environment for turning on the system.

FIGS. 2a and 2b are flow charts of the conventional BIOS when turning on the system. First, when the power of the system is turned on, a data processing device will perform a power-on self test (POST) (step 100). The data processing device will subsequently check the keyboard status and perform specific key-in commands (step 110). Then the data processing device detects the memory thereof and the setting status of the memory (step 120), and detects the peripheral devices thereof and the setting statuses of the devices (step 130). The data processing device will determine whether to enter into the BIOS setup menu (step 140). If the BIOS setup menu is not entered, the BIOS setup procedure ends and the flow is finished; otherwise, if the BIOS setup menu is not entered, the user interface of the setup menu will be shown and the flow goes to the setup procedure (step 150). After the foregoing procedure, it will determine whether to exit from the setup menu (step 160). If not, step 150 is repeated. If yes, then it will re-confirm whether the setting is saved (step 170). If the user chooses not to save the setting, the flow is finished. If the user chooses to save the setting, the BIOS setting will be saved to a CMOS (step 180) and the flow is then finished.

As shown in FIGS. 2a and 2b, a computer system after power-on will perform a POST via BIOS, and check and set the statuses of the system. If the user chooses not to enter into the BIOS setup menu, BIOS completes the procedure for turning on the computer. On the other hand, if the user chooses to enter into the BIOS setup menu, the BIOS will enter into the setup procedure so that the user can change the configuration of the computer system and save the change to the CMOS memory and choose to exit from the setup menu. Upon exiting from the setup menu, BIOS will automatically reset and restart the system to effect the change.

FIGS. 3a and 3b are conventional flow chart for updating the BIOS setting. First, when power of the system is turned on, a data processing device will perform a POST (step 200). The data processing device will subsequently check the keyboard status and perform specific key-in commands (step 210). Then the data processing device detects the memory thereof and the setting status of the memory (step 220), and detects the peripheral devices thereof and the setting statuses of the devices (step 230). The data processing device will determine whether to enter into the BIOS setup menu (step 240). If the BIOS setup menu is not entered, the BIOS setup procedure ends and the flow is finished; otherwise, if the BIOS setup menu is entered, the user interface of the setup menu will be shown and the flow goes to the setup procedure (step 250). Then the user changes the BIOS setting (step 260). After the foregoing procedure, it will be determined whether to exit from the setup menu (step 270). If not, step 250 is repeated. If yes, then it will re-confirm whether the setting is saved (step 280). If the user chooses not to save the setting, the flow is finished. If the user chooses to save the setting, the BIOS setting will be saved to a CMOS (step 290) and the flow is then finished.

As described in the foregoing, to change the BIOS setting, the user has to enter into the setup menu and manually changes each item, which wastes a lot of time (at least 35 seconds) and causes the inconvenience of the user. Hence, how to effectively and flexibly update the BIOS setting is an important issue.

### SUMMARY OF INVENTION

In the light of the foregoing, an object of the present invention is to provide a method for updating BIOS setting allowing the user to change the setting in a few second after power-on in order to save the time and make it more convenient for the user to update the BIOS setting.

The present invention provides a method for updating a basic input output system (BIOS), comprising the following steps: providing a memory to store at least one system configuration setting; performing a power-on self testing by a data processing device; the data processing device checking a keyboard status, performing specific key-in commands, and determining whether the set of system configuration settings is triggered; the data processing device detecting the memory thereof and a setting status of the memory; the data processing device detecting peripheral devices thereof and a setting status of the peripheral devices; determining whether to enter into a setup menu of the BIOS; displaying a user interface of the setup menu and functions of the system configuration setting selected by the user; determining whether to exit from the setup menu; confirming whether to save a change of the system configuration setting; and saving the change of the system configuration setting into a complementary metal-oxide semiconductor (CMOS).

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows the interaction between the conventional BIOS firmware and the CMOS hardware.

FIGS. 2a and 2b are flow charts illustrating the conventional BIOS when turning on the system.

FIGS. 3a and 3b are flow charts illustrating conventional procedure of updating the BIOS setting.

FIG. 4 is a diagram showing the interaction between the BIOS firmware and the CMOS hardware, after an additional memory is added, of the present invention.

FIGS. 5a and 5b are flow charts of the BIOS when turning on the system in accordance with the present invention.

FIG. 6 is a flow chart illustrating a method for fast changing the BIOS setting in accordance with the present invention.

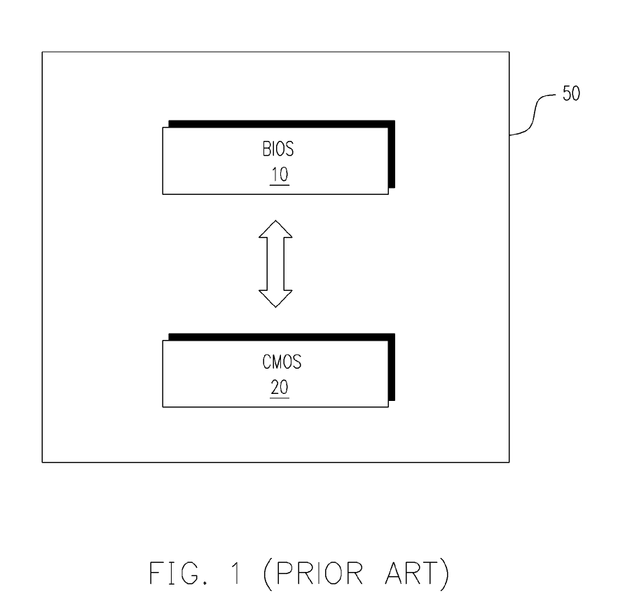

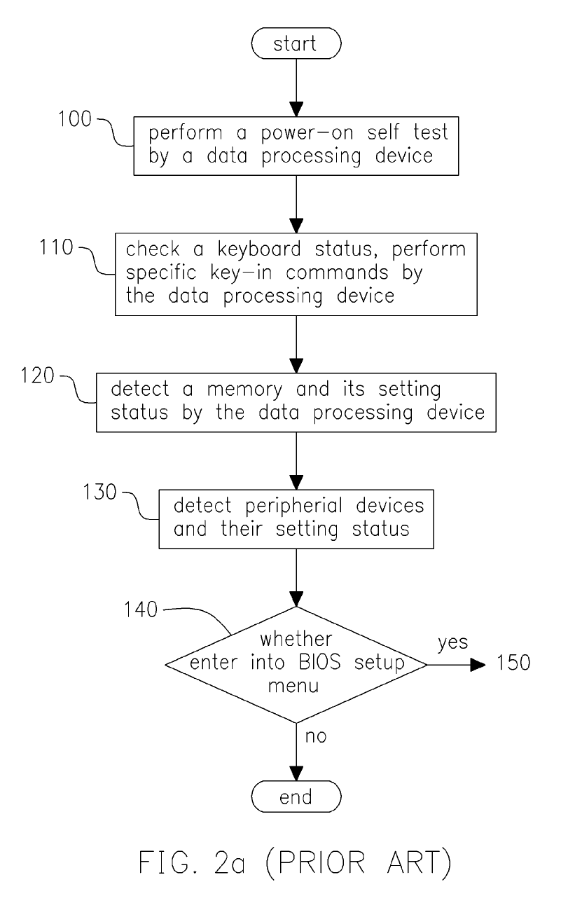

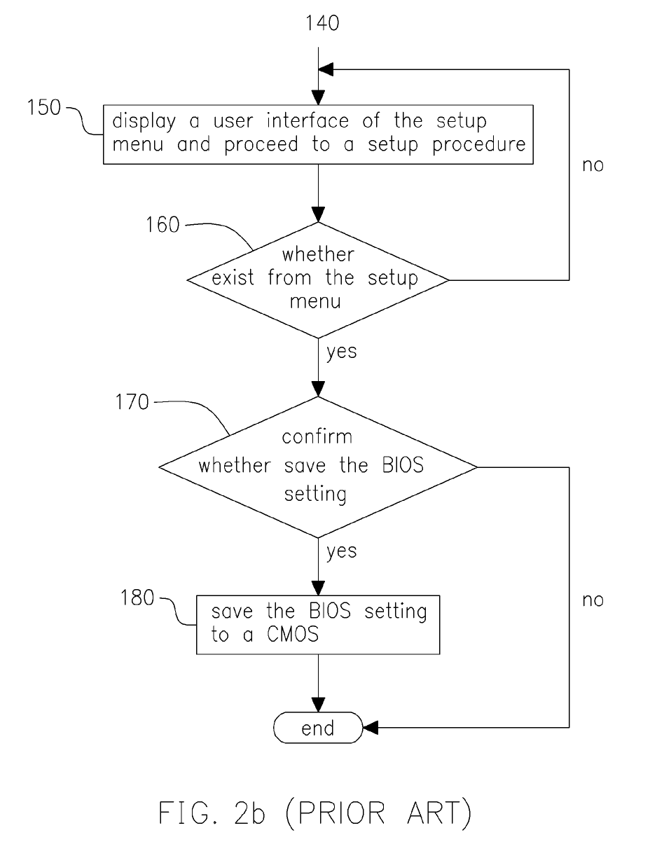

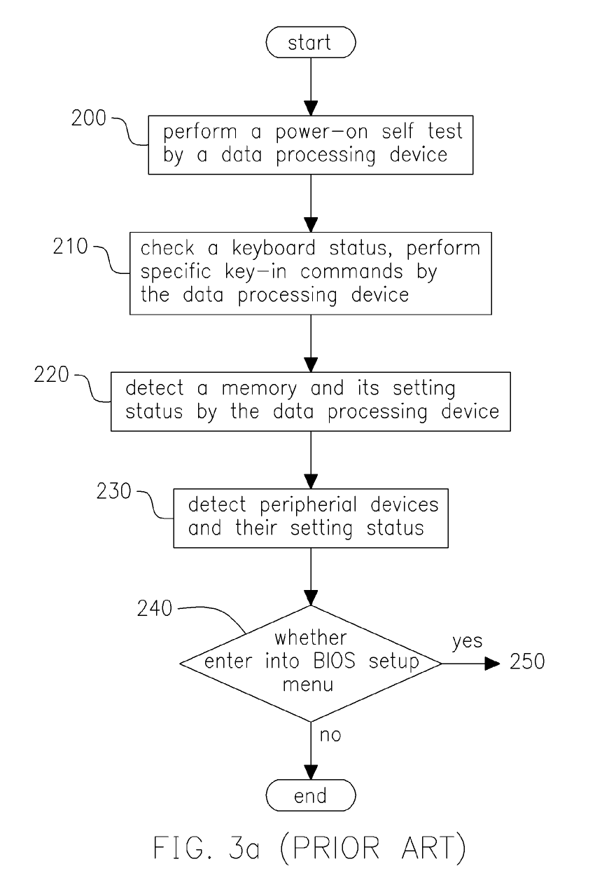

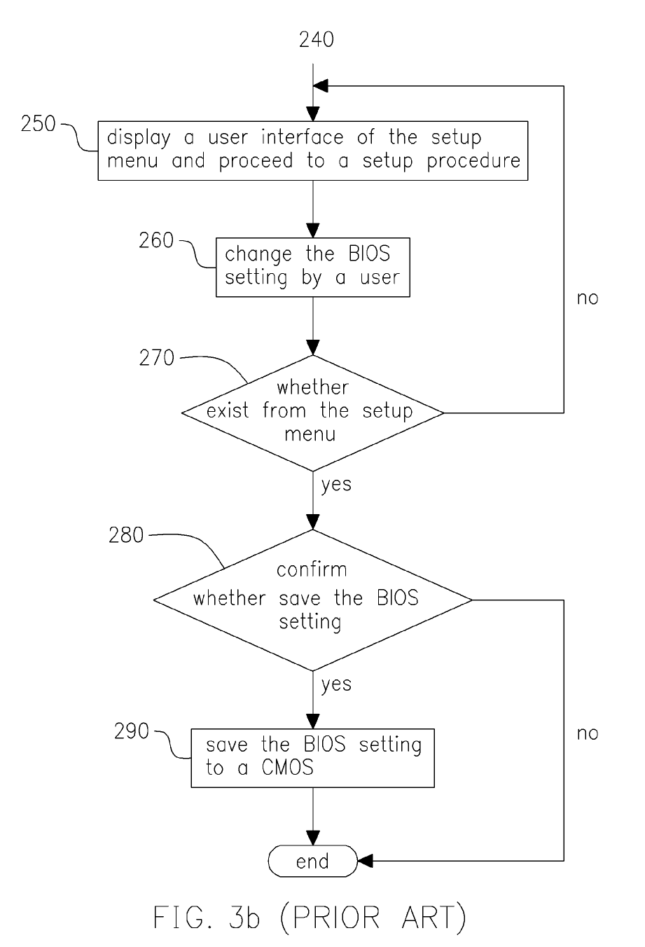

### DETAILED DESCRIPTION

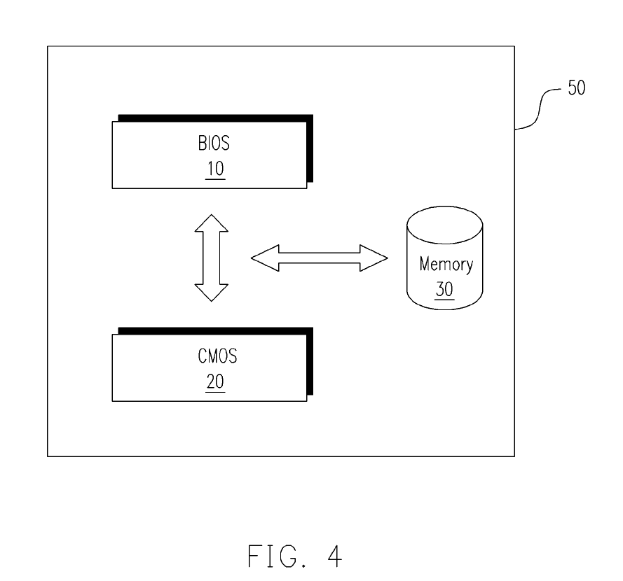

FIG. 4 shows the interaction between the BIOS firmware and the CMOS hardware, after an additional memory is added, of the present invention. After the additional memory is added, additional functions can be added into the conventional BIOS power-on procedure. With those additional functions, more sets of system configuration settings can be saved in order to more conveniently and faster change different system configuration settings.

As shown in FIG. 4, the present invention uses additional memory to backup the data in CMOS, i.e., the memory is used to store the configuration of the computer system. When the additional memory 30 has sufficient space, a plurality of settings of the CMOS data can be backed up in the memory 30.

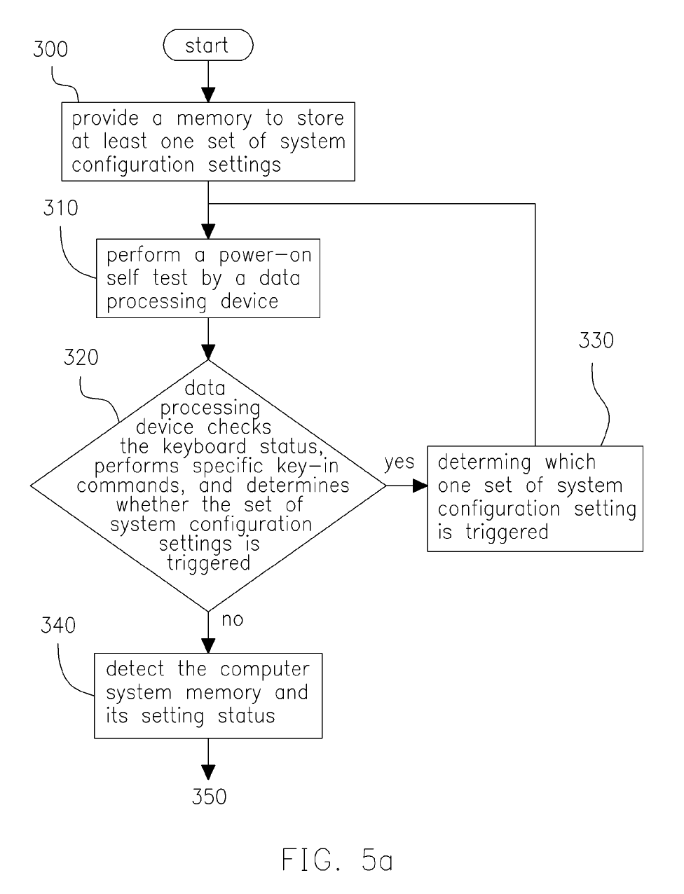

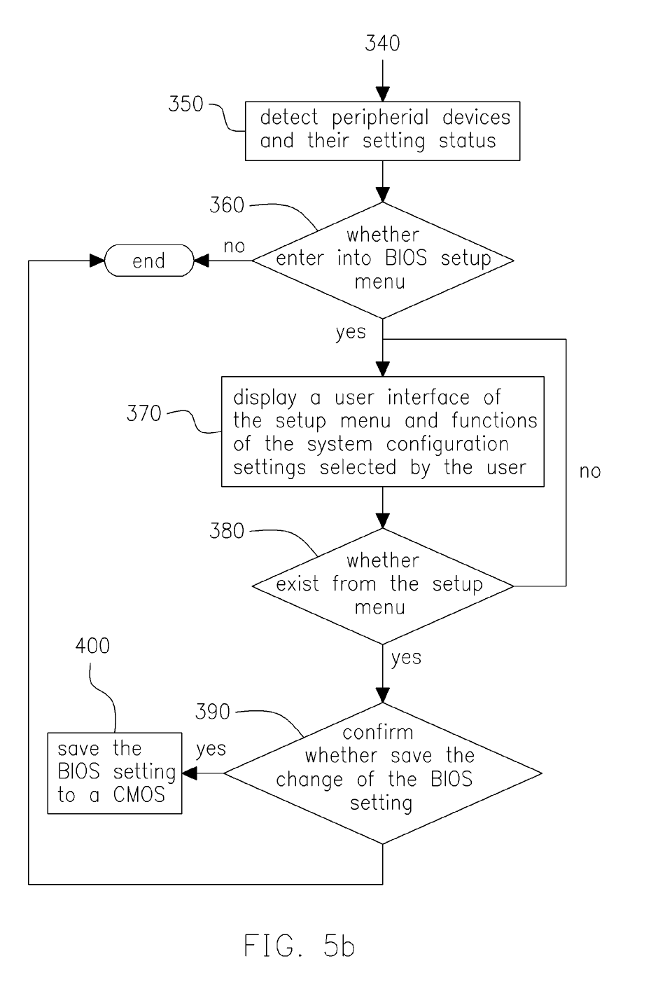

FIGS. 5a and 5b are flow charts showing the BIOS when turning on the system in accordance with the method of updating the BIOS of the present invention. The process is described as follows.

First, a memory 30 is set to store at least one set of system configuration settings (step 300). A power-on self test is performed by a data processing device 30 (step 310). Then the data processing device 50 checks the keyboard status and performs specific key-in commands, and determines whether the set of system configuration settings is triggered (step 320). If the set of system configuration settings is triggered, then the data processing device 50 further determines which one of the set of system configuration settings is triggered (step 330) and the flow returns to the step 310. If the set of system configuration settings is not triggered, the data processing device 50 detects the computer system memory and the setting status of the memory (step 340). Then the data processing device 50 detects the peripheral devices of the data processing device 50 and the setting status of the peripheral devices (step 350) in order to determine whether to enter into a setup menu of the BIOS 10 (step 360). If the BIOS setup menu is not entered, the BIOS setup procedure ends and the flow is finished. If the BIOS setup menu is entered, a user interface of the setup menu will be displayed to show functions of the system configuration setting selected by the user (step 370). After the foregoing procedure, it will be determined whether to exit from the setup menu (step 380). If not, the step 370 is repeated. If yes, then it confirms whether to save the change of the BIOS setting (step 390). If the user chooses not to save the setting, the flow is finished. If the user chooses to save the setting, the BIOS setting will be saved to a CMOS 20 (step 400) and the flow is then finished.

The foregoing data processing device 50 can be, for example, a desktop computer, a notebook computer, a personal digital assistant (PDA), or a handheld data processing device.

The step 320 can be in two modes, i.e., a reset mode and a writing mode. The reset mode refers to resetting a data in the CMOS 20 via an input device. This function allows the user to conveniently clear the CMOS data via an input device without having a switch as required in the prior art.

The writing mode refers to writing CMOS data backed up in the memory selected by an input device directly into the CMOS hardware, and the CMOS saving the backup data. This function allows the user to directly write the backup system configuration settings into the CMOS 20 via the input device, so that the user can change the system configuration settings in a few seconds after power-on without entering into the setup menu.

The step 370 can be in a backup mode, a loading mode, or a renaming mode. The backup mode refers to backing up data in the CMOS 20 to the memory 30. This function allows the user to store a plurality sets of system configuration settings for backup purpose.

The loading mode refers to loading CMOS 20 data backed up in the memory 30 to the CMOS 20. Hence, the current system configuration setting is back to the backup system configuration setting.

The renaming mode refers to allowing the user to rename the setting displayed in the setup menu. This function allows the user to change the name of each item of the system configuration settings so that the user will understand the purpose of the system configuration setting.

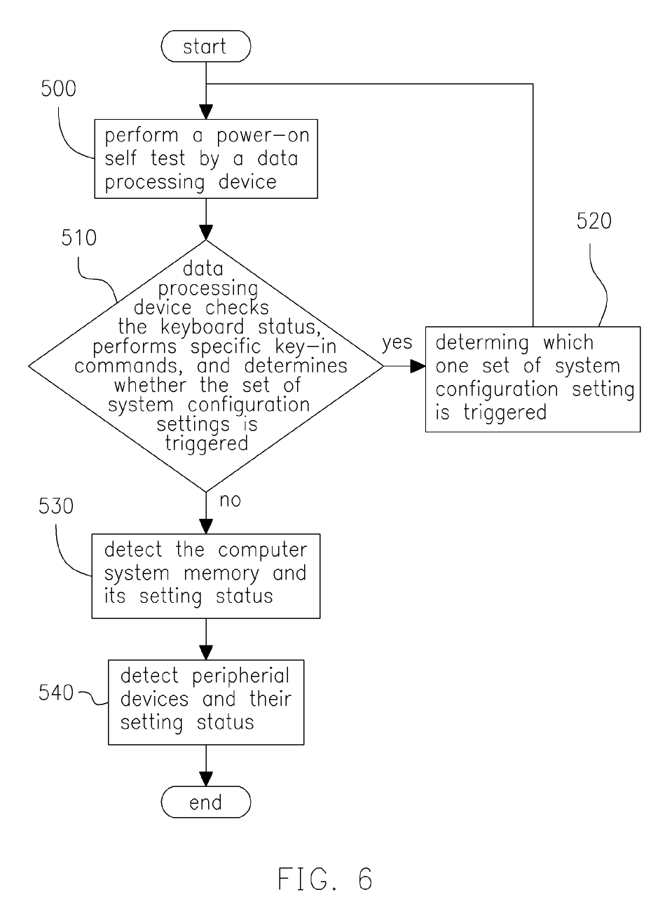

The detecting mode will be illustrated as follows. FIG. 6 is a flow chart that illustrates a method of fast changing the BIOS setting in accordance with the present invention. Upon the user backs up the different sets of system configuration settings shown in the flow charts of FIGS. 5a and 5b, the writing mode can be used to change between the different sets of system configuration settings. This function allows the user to fast change the system configuration setting in a few seconds after power-on without entering into the setup menu. Hence, it saves the user a lot of time and enables the user more conveniently change the system configuration settings.

First, the data processing device 50 performs a power-on self test (step 500). Then the data processing device 50 checks a keyboard status, performs specific key-in commands, and determines whether the set of system configuration settings is triggered (step 510). If the set of system configuration settings is triggered, the data processing device 50 determines which one of the set of system configuration settings is triggered (step 520), and the flow returns to the step 500. If the set of system configuration settings is not triggered, the data processing device 50 detects a computer system memory and the setting status of the memory (step 530), and detects its peripheral devices and a setting status of the peripheral devices (step 540), and then the flow is finished.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A method for updating a BIOS (basic input output system), comprising:
providing a memory to store at least one set of system configuration settings;
performing a power-on self test by a data processing device;
the data processing device checking a keyboard status, performing specific key-in commands, and determining whether said set of system configuration settings is triggered;
detecting said memory and a setting status of said memory by said data processing device;
detecting peripheral devices of said data processing device and a setting status of said peripheral devices;
determining whether to enter into a setup menu of said BIOS;
displaying a user interface of said setup menu and functions of said system configuration settings selected by the user;
determining whether to exit from said setup menu;
confirming whether to save a change of said system configuration settings; and
saving said change of said system configuration settings into a CMOS (complementary metal-oxide semiconductor).

2. The method of claim 1, wherein said step of the data processing device checking said keyboard status, performing specific key-in commands, and determining whether said set of system configuration settings is triggered includes a reset mode and a writing mode.

3. The method of claim 2, wherein said reset mode includes resetting data in said CMOS via an input device.

4. The method of claim 2, wherein said writing mode includes writing data of said CMOS backed up in said memory selected by an input device directly into hardware of said CMOS, and said CMOS saving said backup data in said memory selected by said input device.

5. The method of claim 1, wherein said data processing device is a desktop computer, a notebook computer, a personal digital assistant, or a handheld data processing device.

6. The method of claim 1, wherein said step of displaying said user interface and functions includes a backup mode, a loading mode, and a renaming mode.

7. The method of claim 6, wherein said backup mode includes backing up data in said CMOS to said memory.

8. The method of claim 6, wherein said loading mode includes loading backup data in said memory backed up from said CMOS to said CMOS.

9. The method of claim 6, wherein said renaming mode includes allowing the user to rename an item displayed in said setup menu.

10. A method for updating a BIOS to simplify change of a setting for said BIOS by pre-disposing a memory to store at least one set of system configuration settings, said method comprising:
performing a power-on self test by a data processing device;
checking a keyboard status, performing specific key-in commands, and determining whether said set of system configuration settings is triggered;
determining which one of said set of system configuration settings is triggered;
detecting a computer system memory and a setting status of said computer system memory by said data processing device; and
detecting peripheral devices of said data processing device and a setting status of said peripheral devices.

11. The method of claim 10, wherein said step of checking said keyboard status, performing specific key-in commands, and determining whether said set of system configuration settings is triggered includes a reset mode and a writing mode.

12. The method of claim 11, wherein said reset mode includes resetting a data in said CMOS via an input device.

13. The method of claim 11, wherein said writing mode includes writing a backup data in said memory selected by an input device directly into hardware of said CMOS, and said CMOS saving said backup data in said memory selected by said input device.

14. The method of claim 10, wherein said data processing device is a desktop computer, a notebook computer, a personal digital assistant, or a handheld data processing device.
